(19) United States
(12) Patent Application Publication
(10) Pub. No.: US 2026/0299974 A1
(43) Pub. Date: Oct. 1, 2026

(54) SYSTEMS AND METHODS FOR GENERATING A GUI FOR PROCESSING BY A GENERATIVE MACHINE LEARNING MODEL

(71) Applicant: Shopify Inc., Ottawa (CA)

(72) Inventor: Ates Göral, Toronto (CA)

(21) Appl. No.: 19/207,790

(22) Filed: May 14, 2025

Related U.S. Application Data
(60) Provisional application No. 63/777,234, filed on Mar. 25, 2025.

(51) Int. Cl. G06F 9/451; G06F 40/143; G06T 11/00

(52) U.S. Cl. CPC G06F 9/451; G06F 40/143; G06T 11/10; G06T 2200/24

(57) ABSTRACT

Frames depicting a graphical user interface (GUI), e.g. that may be presented to a user, may not be well suited for processing by a multimodal generative machine learning (ML) model. For example, frames may undergo some distortion in order to be resized to dimensions that are suitable for inference by the generative ML model. As such the image may be scaled down and certain GUI elements may be missing, distorted or otherwise skewed. Additionally, the frames may include particular fonts and/or colours, etc. that are difficult from an image processing perspective to be clearly read/interpreted by the generative ML model. To address this problem, computer-executable code defining model-specific styling can be obtained and applied to a set of GUI elements. Then, when the set of GUI elements is rendered, the resulting GUI may be better suited for use in prompting the generative ML model.

### CROSS-REFERENCE TO RELATED APPLICATION

The present application claims the benefit of U.S. Provisional Patent Application Ser. No. 63/777,234 filed on Mar. 25, 2025, which is incorporated herein by reference.

### FIELD

The present application relates to generative machine learning models, such as multimodal models, that generate content based on graphical user interfaces (GUIs).

### BACKGROUND

In machine learning, a generative model is a model that utilizes machine learning (ML) to generate content, such as text or images, e.g. in response to an input prompt. A generative model may sometimes be referred to as generative artificial intelligence (AI). An example of a generative model is a generative multimodal model. A generative multimodal model generates content, e.g. text, in response to an input prompt. The input prompt may comprise different modalities of input, e.g. image input, audio input, and/or text input.

Multimodal generative ML models may be trained on images that have a specific aspect ratio, specific dimensions, and/or a specific resolution.

### SUMMARY

Multimodal generative ML models may be employed to guide users of a software application in real time. In order to guide users, a multimodal generative ML model may be provided with access to view the user's screen. Such a scenario may occur, for example, in a customer support interaction where a human user initiates a video call and/or screen-sharing session with an AI support agent. The AI support agent may be powered by a multimodal generative ML model which may be capable of processing video frames and/or screenshots and understanding them semantically.

Before being transmitted to a generative ML model, any frames depicting the user's screen/graphical user interface (GUI) may undergo some distortion in order to be resized to dimensions that are suitable for inference by the generative ML model. In some cases, such changes may result in inaccuracies in the model's ability to understand the contents of the image. For example, an original image of a webpage may include the value $50.99. The image may be presented to the user on a large widescreen display with an ultrawide aspect ratio of 21:9 and a resolution of 2560×1080. The model, however, may be trained on images that were of a portrait aspect ratio and much lower resolution e.g. 50×750 pixels. As such the image may be scaled down, such as via down sampling, and certain GUI elements may be missing, distorted or otherwise skewed. In the provided example, the model may misinterpret the “$” as the number 5 and may miss the decimal place, leading to it interpreting the value as 55099. In other cases, words may become completely illegible. Moreover, even if an image depicting a screen/GUI does not undergo resizing, the image may still be rendered in a way that is difficult for the generative ML model to process. For example, the rendered image may include particular fonts and/or colours and/or dimensions, etc. that may be visually pleasing to a human but that are difficult from an image processing perspective to be clearly read/interpreted by the generative ML model.

To address the technical problems explained above, a user-facing GUI may be transformed into a model-facing GUI that is better suited for input into a generative ML model. In one example, a representation of a second GUI, alternatively referred to herein as a model-facing GUI, may be obtained. The representation of the model-facing GUI may be a modified version of a representation of a first GUI, alternatively referred to herein as a user-facing GUI, through which the user interacts with the software application. The model-facing GUI may be rendered. At least one visual component of the model-facing GUI may be modified as compared to the user-facing GUI, e.g. to be better suited for input into the generative ML model. The model-facing GUI, or portions thereof, may be captured and used to prompt the generative ML model. The model-facing GUI may mirror the user's interactions with the user-facing GUI. The model-facing GUI may be continually updated throughout the course of the user's interaction with the generative ML model, e.g. throughout the course of a support session with an AI support agent. By prompting the generative ML model with the model-facing GUI or a portion thereof, instead of the user-facing GUI, the generative model ML may better understand the content of the GUI and therefore may provide more helpful and accurate responses, and technical problems such as hallucination may be mitigated.

In one aspect, there is provided a computer-implemented method. The method may include obtaining a representation of a second GUI (referred to herein as the “model-facing GUI”). The representation of the second GUI may be a modified version of a representation of a first GUI (referred to herein as the “user-facing GUI”) through which a user may interact with a software application. The method may further include rendering the second GUI based on the representation of the second GUI. At least one visual component of the second GUI may be modified compared to the first GUI. The method may further include capturing at least a portion of the second GUI for use in prompting a generative ML model. The method may further include transmitting the at least a portion of the second GUI to the generative ML model.

In some implementations, the representation of the first GUI and the representation of the second GUI may have at least one common GUI element. Styling of the at least one common GUI element may be modified in the representation of the second GUI as compared to the styling of the at least one common GUI element in the representation of the first GUI.

In some implementations, the styling of the at least one common GUI element in the representation of the second GUI may be modified as compared to the styling of the at least one common GUI element in the representation of the first GUI by a modification to at least one of: a colour of the at least one common GUI element, a dimension of the at least one common GUI element, or a font of the at least one common GUI element.

In some implementations, the representation of the first GUI may comprise a plurality of GUI elements. At least one of the plurality of GUI elements may be omitted in the representation of the second GUI.

In some implementations, the method may further include, prior to transmitting the at least a portion of the second GUI, annotating a section of the second GUI. The at least a portion of the second GUI may include the annotated section of the second GUI. In some implementations, the method may further include obtaining a description relating to the section of the second GUI. The method may further include transmitting the description to the generative ML model along with the at least a portion of the second GUI.

In some implementations, the method may further include determining that there is a change in the representation of the first GUI based on user input. The method may further include obtaining a second version of the representation of the second GUI reflecting the change in the representation of the first GUI. The method may further include rendering the second GUI based on the second version of the representation of the second GUI.

In some implementations, the method may further include rendering and presenting the first GUI to the user. The method may further include determining a section of the first GUI with which the user is interacting. The method may further include determining a corresponding section of the second GUI that corresponds to the section of the first GUI. Capturing the at least a portion of the second GUI for use in prompting the generative model may comprise capturing the corresponding section of the second GUI. In some implementations, determining the section of the first GUI with which the user is interacting may comprise identifying at least one GUI element with which the user is interacting. The corresponding section of the second GUI may be determined based on the at least one GUI element with which the user is interacting. In some implementations, determining the section of the first GUI with which the user is interacting may be based on at least one of: a pointer movement on the first GUI, a pointer location on the first GUI, or a user selection of an element of the first GUI.

In another aspect, there is provided a computer-implemented method. The method may include obtaining computer-executable code defining styling to be applied to GUI elements representing visual components that may form the basis of prompts to a generative ML model. The computer-executable code may comprise rules styling the GUI elements for the generative ML model. The method may further include rendering a GUI based on the rules without presenting the GUI on a display. Alternatively, the GUI may be presented on the display. The method may further include capturing at least a portion of the GUI for use in prompting the generative ML model. The method may further include transmitting the at least a portion of the GUI to the generative ML model.

In some implementations, the computer-executable code may comprise cascading style sheets (CSS) source code.

In some implementations, the styling may be a first styling. The method may further include obtaining other computer-executable code defining second styling to be applied to the GUI elements. The method may further include rendering the GUI elements based on the second styling for presentation on the display. The first styling may be modified compared to the second styling by a modification to at least one of: a colour of at least one of the GUI elements, a dimension of at least one of the GUI elements, or a font of at least one of the GUI elements.

In some implementations, the rules styling the GUI elements for the generative ML model may comprise at least one rule that, when applied to a GUI element, affects at least one colour attribute of the GUI element.

In some implementations, rendering the GUI may comprise determining that a GUI element includes an image. Rendering the GUI may further comprise annotating the image with defined alt text.

In some implementations, the rules styling the GUI elements for the generative ML model may comprise at least one rule that, when applied to the GUI elements, arranges the GUI elements such that the GUI has a specific aspect ratio and/or resolution. In some implementations, the generative ML model may have been trained using GUIs with the specific aspect ratio and/or resolution.

In some implementations, the method may further include, prior to transmitting the at least a portion of the GUI to the generative ML model, identifying at least one section of the captured portion of the GUI. The method may further include annotating the captured portion of the GUI to indicate the at least one section. In some implementations, the method may further include obtaining a description relating to the at least one section. The method may further include transmitting the description to the generative ML model along with the at least a portion of the GUI.

In some implementations, the method may further include, subsequent to transmitting the at least a portion of the GUI to the generative ML model, receiving, from the generative ML model, a request for a particular portion of the GUI. The particular portion may be different from the at least one portion of the GUI transmitted to the generative ML model. The method may further include capturing the particular portion of the GUI. The method may further include transmitting the particular portion of the GUI to the generative ML model.

In another aspect, there is provided a computer readable medium having stored thereon computer-executable instructions that, when executed by a computer, cause the computer to perform any of the methods disclosed herein. The computer readable medium may be non-transitory.

In another aspect, a system is provided that is configured to perform the methods disclosed herein. For example, the system may include at least one processor and a memory storing processor-executable instructions that, when executed by the at least one processor, cause the system to perform any of the methods disclosed herein.

### BRIEF DESCRIPTION OF THE DRAWINGS

Embodiments will be described, by way of example only, with reference to the accompanying figures wherein:

FIG. 1A is a block diagram of a simplified convolutional neural network.

FIG. 1B is a block diagram of a simplified transformer neural network.

FIG. 2 is a block diagram of an example computing system, which may be used to implement examples of the present disclosure.

FIG. 3 illustrates an example system for generating GUIs for processing by a generative ML model.

FIG. 4 illustrates an example method performed by the system of FIG. 3.

FIG. 5 illustrates an example representation of a user-facing GUI.

FIG. 6 illustrates an example user-facing GUI.

FIG. 7 illustrates an example representation of a model-facing GUI.

FIG. 8 illustrates an example model-facing GUI.

FIGS. 9-12 illustrate examples corresponding to the steps of the method of FIG. 4.

FIG. 13 illustrates another example system for generating GUIs for processing by a generative ML model.

FIG. 14 illustrates an example of GUI elements.

FIG. 15 illustrates another example method performed by the system of FIG. 13.

FIG. 16 illustrates an example of modifying styling information.

### DETAILED DESCRIPTION

For illustrative purposes, specific embodiments will now be explained in greater detail below in conjunction with the figures.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

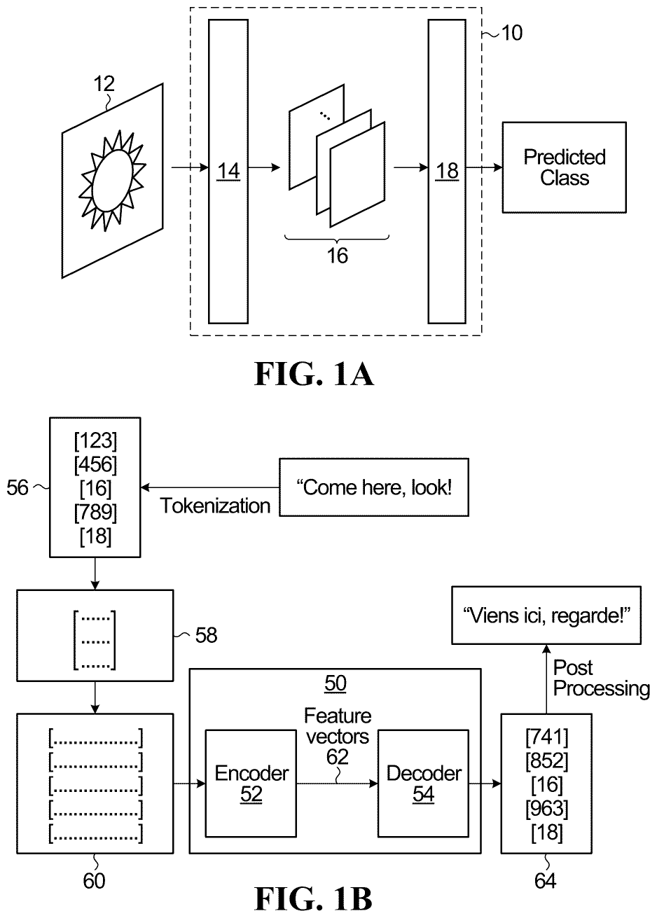

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabeled. LLMs may be trained on a large unlabeled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

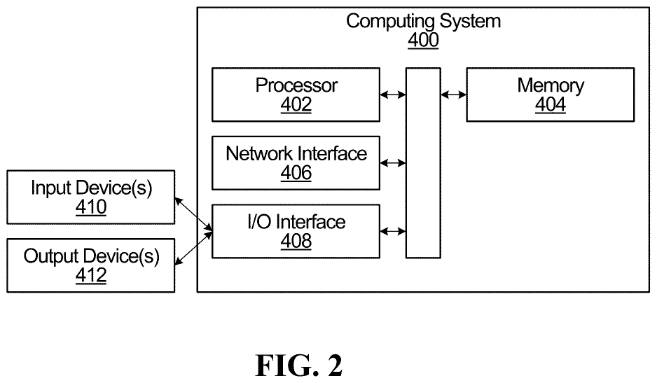

FIG. 2 illustrates an example computing system 400, which may be used to implement examples of the present disclosure, such as a prompt generation engine to generate prompts to be provided as input to a language model such as a LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

### Generating GUIs for Optimal Processing by a Generative ML Model

The LLM described above is an example of a generative ML model. A generative ML model is a model that utilizes machine learning to generate content, e.g. in response to an input prompt. A generative ML model does not need to be limited to a generative language model such as an LLM. For example, a generative ML model may be multimodal meaning that the input prompt may comprise different modalities of input, e.g. image input, text input, audio input etc.

It may be desirable to prompt a multimodal generative ML model with at least a portion of a particular GUI, e.g. in a scenario where the generative ML model is employed to guide a user of a software application by “seeing” what the user sees. In such a scenario, the particular GUI will be referred to as a user-facing GUI because it is the GUI through which the user interacts with the software application. However, multimodal generative ML models are typically trained on images that are of a specific aspect ratio, with specific dimensions, and/or with a specific resolution. As such, any transmitted frames depicting the user-facing GUI may undergo some distortion in order to be resized to dimensions that are suitable for inference by the generative ML model. As such the image may be scaled down, such as via down sampling, and certain GUI elements may be missing, distorted or otherwise skewed. In some cases, such changes may result in inaccuracies in the model's ability to understand the contents of the image. Even if the transmitted frames do not undergo resizing, the frames may still be rendered in a way that is difficult for the generative ML model to process. For example, the rendered frames may include particular fonts and/or colours and/or dimensions, etc. that may be visually pleasing to a human but that are difficult from an image processing perspective to be clearly read/interpreted by the generative ML model.

To address the problems above, a model-facing version of the user-facing GUI, referred to herein as the model-facing GUI, may be generated. The model-facing GUI may be a modified version of the user-facing GUI, e.g. at least one visual component of the model-facing GUI may be modified compared to the user-facing GUI. The model-facing GUI may be better suited for use in prompting a generative ML model. The model-facing GUI may be continually updated to match the state of the user-facing GUI. By rendering the model-facing GUI and prompting a generative ML model with portions of the model-facing GUI, instead of the user-facing GUI, the generative ML model may better understand the content of the GUI and therefore may provide more helpful and accurate responses, and technical problems such as hallucination may be mitigated.

Rendering, as used herein, refers to the process of digitally drawing GUI elements as visual components for display, although it is not necessary that a rendered GUI necessarily be displayed on a display screen. Rendering may include adjusting styling of GUI elements such that the GUI has a specific aspect ratio or resolution. Rendering is different from down-sampling or up-sampling methods which rely on manipulating the number of pixels in a GUI without altering the layout or styling of the GUI elements.

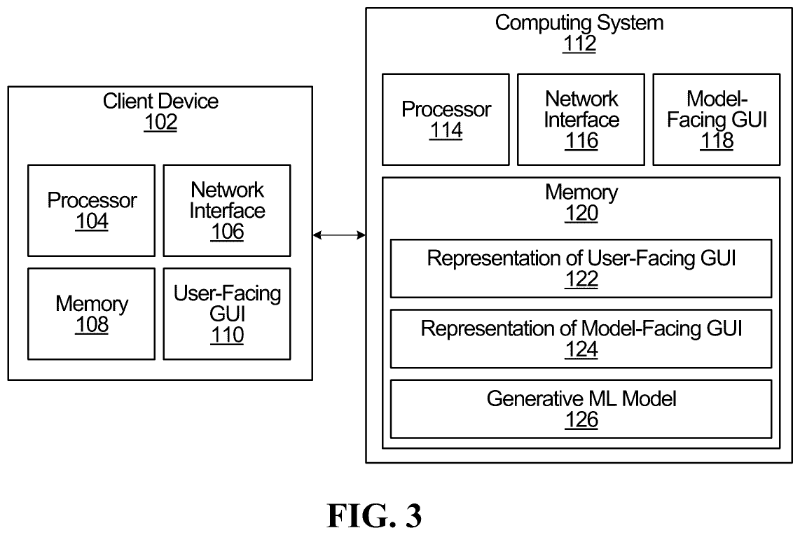

FIG. 3 illustrates an example system for generating GUIs for processing by a generative ML model. The system includes a client device 102. The client device 102 is a device used by a user to interact with computing system 112. For example, the client device 102 may be a personal computer, or a laptop, or desktop computer, or mobile device such as a tablet or smartphone, or an augmented reality (AR) device, etc., depending upon the implementation. The client device 102 includes a processor 104, a network interface 106, a memory 108, and a user-facing GUI 110. The processor 104 controls the operations of the client device 102. The processor 104 may be implemented by one or more processors that execute instructions stored in the memory 108. Alternatively, some or all of the processor 104 may be implemented using dedicated circuitry, such as an application specific integrated circuit (ASIC), a graphics processing unit (GPU), or a programmed field programmable gate array (FPGA). The network interface 106 interfaces with a network (not illustrated) to perform communication (transmit/receive) over the network. The network may be, for example, the Internet or an Intranet or local network. The structure of the network interface 106 will depend on how the client device 102 interfaces with the network. For example, if the client device 102 is connected to the network with a network cable, the network interface 106 may comprise a network interface card (NIC), and/or a computer port (e.g. a physical outlet to which a plug or cable connects), and/or a network socket, etc. If the client device 102 is a wireless device, such as a mobile phone or laptop, the network interface 106 might be or include a transmitter/receiver with an antenna to send and receive wireless transmissions to/from the network. The memory 108 stores information (e.g. content and/or instructions, etc.). The user-facing GUI 110 allows the user (e.g. a human) to provide input to and receive output from the client device 102. For example, the user-facing GUI 110 may be displayed, e.g. on a screen, and the user may manipulate the user-facing GUI 110 using a keyboard, and/or a mouse, and/or a touchscreen, etc. The user-facing GUI 110 may allow the user to interact with a software application. The user-facing GUI 110 may be rendered by processor 104 based on a representation of the user-facing GUI 122 (described below) that is received by client device 102.

The system of FIG. 3 may further include a computing system 112. Computing system 112 may implement a software application with which the user is interacting using client device 102. Client device 102 and computing system 112 may communicate over a network, e.g. the Internet or an Intranet or a local network. The computing system 112 may be (or may be part of) a computing platform that is accessible to the client device 102 and that provides services to the client device 102. For example, the computing system 112 might be a server that is part of the computing platform serving the client device 102.

The computing system 112 includes a processor 114, a network interface 116, and a memory 120. The processor 114 controls the operations of the computing system 112. The processor 114 may be implemented by one or more processors that execute instructions stored in the memory 120. Alternatively, some or all of the processor 114 may be implemented using dedicated circuitry, such as an application specific integrated circuit (ASIC), a graphics processing unit (GPU), or a programmed field programmable gate array (FPGA). The memory 120 stores information (e.g. content and/or instructions, etc.). The network interface 116 interfaces with a network to perform communication (transmit/receive) over the network. The network may be, for example, the Internet or an Intranet or local network. The structure of the network interface 116 will depend on how the computing system 112 interfaces with the network. For example, if the computing system 112 is connected to the network with a network cable, the network interface 116 may comprise a network interface card (NIC), and/or a computer port (e.g. a physical outlet to which a plug or cable connects), and/or a network socket, etc. If the computing system 112 is part of a wireless device, such as a mobile phone or laptop, the network interface 116 might be or include a transmitter/receiver with an antenna to send and receive wireless transmissions to/from the network.

In some implementations, the computing system 112 may be distributed, e.g. it may comprise one or more servers or computing devices, in which case processor 114 might actually consist of multiple processors communicating with each other over a communication link (e.g. over a network), and similarly memory 120 might be distributed across multiple servers or computing devices.

In the example system, the computing system 112 further includes a model-facing GUI 118. The model-facing GUI 118 may be a modified version of the user-facing GUI 110. The model-facing GUI 118 may be rendered without being presented on a display. The model-facing GUI 118 may be rendered by processor 114 based on a representation of the model-facing GUI 124 (described below).

In the example system, the memory 120 stores a representation of the user-facing GUI 122. The representation of the user-facing GUI 122 may comprise a plurality of GUI elements. The term GUI element, as used herein, refers to a component, widget, node etc. that represents a visual component of a GUI. A GUI element may be an HTML element (e.g. button, input, div, img, etc.), a window, a pointer, a menu, a container, a text box, an icon, etc. GUI elements may be nested, e.g. a GUI element may have parent, sibling, and/or child GUI elements. A GUI element may have associated styling information, e.g. associated cascading style sheets (CSS) code. Each GUI element of the representation of the user-facing GUI 122 may represent a visual component of the user-facing GUI 110. The representation of the user-facing GUI 122 may also comprise information in addition to GUI elements and their associated styling, e.g. event handling instructions.

The memory 120 also stores a representation of the model-facing GUI 124. The representation of the model-facing GUI 124 may comprise a plurality of GUI elements. Each GUI element of the representation of the model-facing GUI 124 may represent a visual component of the model-facing GUI 118. The representation of the model-facing GUI 124 may also comprise information in addition to GUI elements and their associated styling, e.g. event handling instructions.

In a variation of FIG. 3 not illustrated, the computing system 112 does not need to exist or it may be one and the same as the client device 102. The remaining explanation assumes the scenario actually illustrated in FIG. 3, i.e. a computing system 112 separate from the client device 102. However, it will be appreciated that in all scenarios described herein the operations performed by the computing system 112 could alternatively be performed by the client device 102 in the absence of the separate computing system 112 and/or if the computing system 112 were considered part of or the same as the client device 102, depending upon the implementation.

In the example system, the memory 120 further stores generative ML model 126. By “storing” the generative ML model 126, it is meant that the parameters and other values that make up the model and that are required for execution of the model are stored. The parameters depend upon how the generative ML model 126 is implemented. For example, assuming the generative ML model 126 utilizes one or more neural networks, the weights and biases of the one or more neural networks are stored.

The generative ML model 126 may be implemented as or using a multimodal model. In some implementations, generative ML model 126 may have a similar structure to the example LLM structure described earlier in relation to FIG. 1B, or it may have another structure. The exact structure of the generative model 312 is implementation specific.

The generative ML model 126 may be implemented by the processor 114. In some implementations, the processor 114 may be or include a specialized processing unit, e.g. one designed to accelerate computer operations of a generative model through parallelization of operations, which may allow for faster execution of the generative ML model 126 compared to a more general-purpose processing unit. For example, the processor 114 may be or include a GPU or a tensor processing unit (TPU) or a neural processing unit (NPU) or a hardware accelerator. In some implementations, the processor 114 may comprise a specialized processing unit paired with a general-purpose processing unit, e.g. a computer, central processing unit (CPU), and/or other computing device such as a server. In some implementations, the processor 114 may be monolithic such as, for example, a single computing device or a single integrated circuit of such a device. However, this is not required. In other implementations, the processor 114 may comprise one or more computing devices acting in cooperation. For example, the processor 114 may consist of a general purpose computing device (e.g., a conventional server) communicatively coupled to a specialized computing device adapted for execution of generative ML models.

In some implementations, the generative ML model 126 may be stored/executed separately, not on the computing system 112. This, for example, may be another form of arrangement involving cooperating computing devices. In a particular example, the computing system 112 may communicate with the generative ML model 126 by sending prompts over a network via a generative model interface, e.g. network interface 116 (which may be an API), to the generative ML model 126 and receiving responses back from the generative ML model 126. In some implementations, the generative ML model 126 may be provided by a software-as-a-service (SaaS) provider, e.g. OpenAI™, Microsoft Azure™, etc.

In another variation of FIG. 3, the client device 102 might generate and/or store the representation of the user-facing GUI 122 and/or the representation of the model-facing GUI 124. The client device 102 might also render the model-facing GUI 118. In such variations, the client device 102 may transmit the representation of the model-facing GUI 124 and/or a portion or all of the rendered model-facing GUI 118 to the computing system 112. The examples below assume the configuration as actually illustrated in FIG. 3, but this is only one possibility.

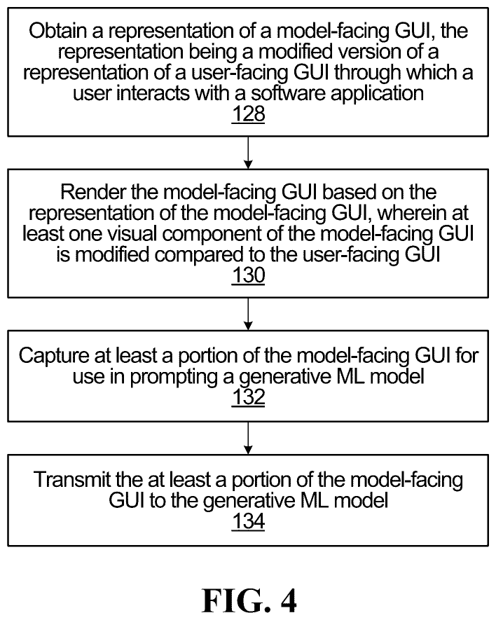

FIG. 4 illustrates an example method performed by computing system 112, according to some implementations.

At step 128, the computing system 112 obtains a representation of a second GUI, which will be referred to hereafter as the model-facing GUI. The representation is a modified version of a representation of a first GUI, which will be referred to hereafter as the user-facing GUI, through which a user interacts with a software application. In some implementations, computing system 112 may obtain the representation of model-facing GUI from memory 120. The representation of the model-facing GUI 124 shown in FIG. 3 is an example of a representation of a model-facing GUI stored in memory 120. In general, the model-facing GUI, user-facing GUI, and their representations referred to in the method of FIG. 4 may be those illustrated in FIG. 3.

At step 130, the computing system 112 renders the model-facing GUI based on the representation of the model-facing GUI. At least one visual component of the model-facing GUI is modified compared to the user-facing GUI. In some implementations, the model-facing GUI may not be visible to the user. For example, the model-facing GUI may be rendered in an off-screen iframe. The off-screen iframe may have an aspect ratio, dimensions, and/or resolution etc. preferred by the generative ML model 126. In another example, the model-facing GUI may be rendered server-side by computing system 112 and not transmitted to the client device 102. However, there may be circumstances in which it is desirable for the model-facing GUI to be visible to the user, in which case the model-facing GUI may be presented on a display. For example, it may facilitate better communication between the user and the generative ML model if the user can see the version of the GUI that the generative ML model relies on. In these circumstances, the model-facing GUI may be transmitted to the client device 102.

At step 132, the computing system 112 captures at least a portion of the model-facing GUI for use in prompting the generative ML model 126. In some implementations, the captured portion of the model-facing GUI may comprise the entire model-facing GUI. In some implementations, only some of the model-facing GUI may be captured. For example, computing system 112 may capture only portions of the model-facing GUI that are of interest in a given context.

At step 134, the computing system 112 transmits the at least a portion of the model-facing GUI to the generative ML model 126. In some implementations, the computing system 112 prompts the generative ML model 126 with the at least a portion of the model-facing GUI. In some implementations, in addition to being prompted with one or more captured portions of the model-facing GUI, the generative ML model 126 may be prompted with additional information. In some implementations, the computing system 112 transmits other information to the generative ML model 126 along with the at least a portion of the model-facing GUI. For example, the computing system 112 may prompt the generative ML model 126 with the at least a portion of the model-facing GUI along with additional text, audio, etc.

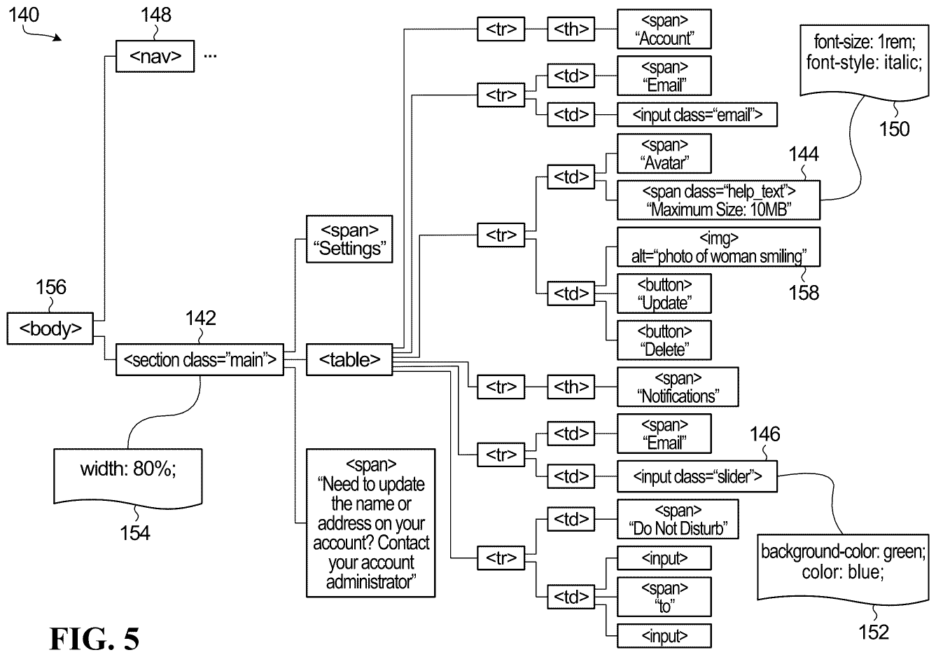

An example of steps 128 to 134 is illustrated in FIGS. 5 to 8. In the illustrated example, both the example model-facing GUI and the example user-facing GUI are implemented using at least HTML elements and CSS styling. As such, both the example representation of the model-facing GUI and the example representation of the user-facing GUI may be depicted as document object model (DOM) trees. In other implementations, the GUIs and their representations may be implemented differently. For example, the GUIs may be implemented using other GUI frameworks/libraries/toolkits, e.g. Tkinter, Swing, WinUI, AppKit, etc.

FIG. 5 illustrates an example representation of the user-facing GUI 140 through which a user interacts with a software application. In the illustrated example, each GUI element that forms part of the example representation of the user-facing GUI 140 is an HTML element which may have associated CSS styling information. Each node of the illustrated DOM tree represents a GUI element. Not all information that may be comprised in the illustrated DOM tree example representation of the user-facing GUI 140 is illustrated. For example, only styling information for section element 142, span element 144, and input element 146 is included. Styling information for other elements is omitted. The example DOM tree representation of the user-facing GUI 140 may also comprise additional GUI elements that are not illustrated. For example, any children elements of nav element 148 are not illustrated in FIG. 5. Additionally, the elements illustrated in FIG. 5 may have additional attributes that are not illustrated. For example, they may have attributes such as class, type, src, id, etc. The example representation of the user-facing GUI 140 may also comprise additional information that is not illustrated, e.g. event handling instructions.

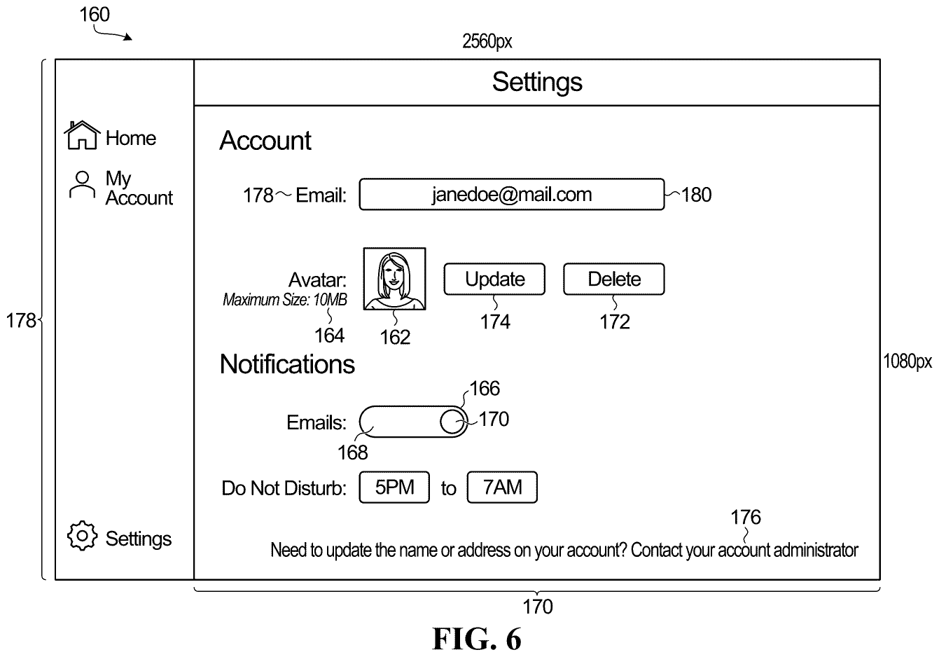

FIG. 6 illustrates an example user-facing GUI 160. In the illustrated example, user-facing GUI 160 is rendered based on the example representation of the user-facing GUI 140 illustrated in FIG. 5. Each GUI element depicted in the DOM tree of FIG. 5 represents a visual component of the example user-facing GUI 160 of FIG. 6. For example, img element 158 in the example representation of the user-facing GUI 140 represents avatar 162 in the example user-facing GUI 160. The styling of a GUI element in the example representation of the user-facing GUI 140 represents styling that is applied to the corresponding visual component in the example user-facing GUI 160. For example, span element 144 in FIG. 5 has styling information 150 comprising a font style of italic. Therefore, text 164 in FIG. 6 (“Maximum Size: 10 MB”), which is the visual component that corresponds to span element 144, is rendered in italics.

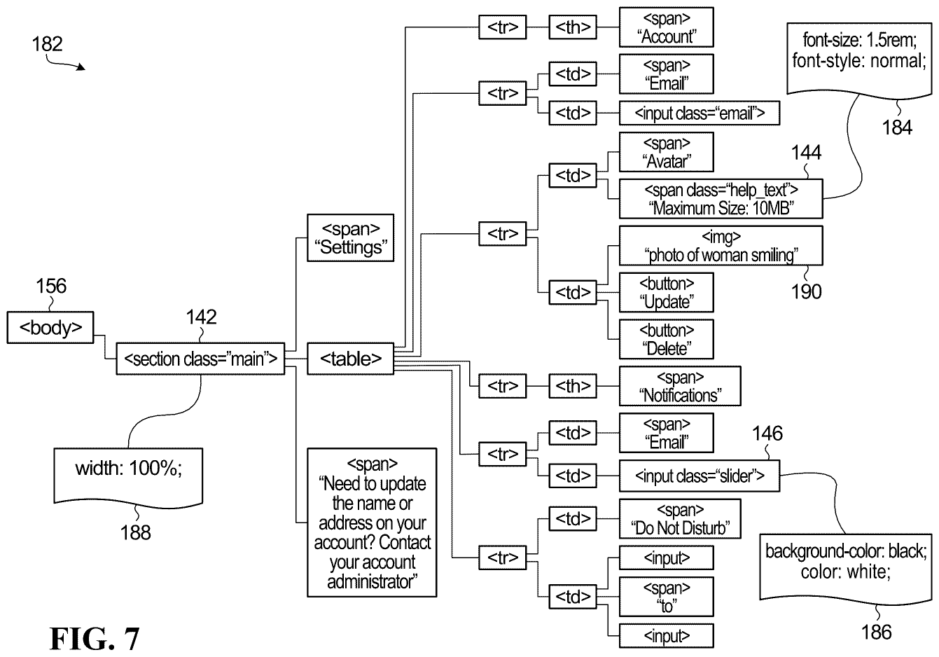

FIG. 7 illustrates an example representation of the model-facing GUI 182, which may be obtained by the computing system 112 at step 128 of the method of FIG. 4. The illustrated example of the representation of the model-facing GUI 182 is a modified version of the example representation of the user-facing GUI 140 illustrated in FIG. 5. In the illustrated example of FIG. 7, each GUI element is an HTML element which may have associated CSS styling information. Each node of the illustrated DOM tree represents a GUI element. Not all information that may be comprised in the example DOM tree representation of the model-facing GUI 182 is illustrated. For example, only styling information for section element 142, span element 144, and input element 146 is included. Styling information for other elements is omitted. The example DOM tree representation of the model-facing GUI 182 may also comprise additional GUI elements that are not illustrated. For example, the example representation of the model-facing GUI 182 may include a root <html>element. Additionally, the elements illustrated in FIG. 7 may have additional attributes that are not illustrated. For example, they may have attributes such as class, type, src, id, etc. The example representation of the model-facing GUI 182 may also comprise additional information that is not illustrated, e.g. event handling instructions.

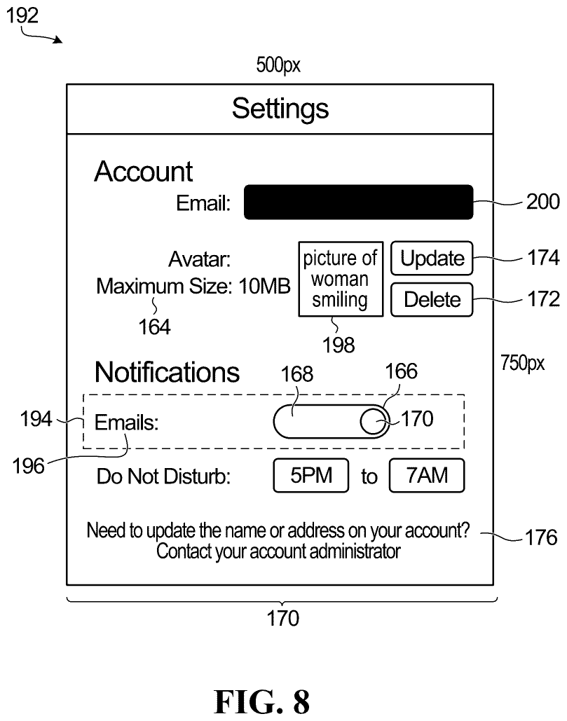

FIG. 8 illustrates an example of the model-facing GUI 192. In the illustrated example, the model-facing GUI 192 is rendered at step 130 of the method of FIG. 4, based on the example representation of the model-facing GUI 182 illustrated in FIG. 7. As such, the example model-facing GUI 192 illustrated in FIG. 8 is a modified version of the example user-facing GUI 160 illustrated in FIG. 6. Each GUI element depicted in the example representation of the model-facing GUI 182 of FIG. 7 represents a visual component of the example model-facing GUI 192 of FIG. 8. For example, input element 146 in the example representation of the model-facing GUI 182 represents slider 166 in the example model-facing GUI 192. The styling of a GUI element in the example representation of the model-facing GUI 182 represents styling that is applied to the corresponding visual component in the example model-facing GUI 192. For example, span element 144 in FIG. 7 has styling information 184 comprising a font style of normal. Therefore, text 164 in FIG. 8, which is the visual component that corresponds to span element 144, is rendered without italics or other character slanting.

At step 132 of the method of FIG. 4 at least a portion of the example model-facing GUI 192 illustrated in FIG. 8 may be captured by the computing system 112. For example, the entire example model-facing GUI 192 may be captured. Then, the captured portion(s) may be transmitted to generative ML model 126.

In some implementations of the method of FIG. 4, the representation of the model-facing GUI and the representation of the user-facing GUI may have at least one common GUI element. Styling of the at least one common GUI element may be modified in the representation of the model-facing GUI as compared to the styling of the at least one common GUI element in the representation of the user-facing GUI. In such implementations, obtaining the representation of the model-facing GUI may include modifying the styling of at least one common GUI element as compared to the styling of the at least one common GUI element in the representation of the user-facing GUI.

In some implementations, a modification of the styling of at least one common GUI element in the representation of the model-facing GUI as compared to in the representation of the user-facing GUI may comprise a modification to a colour of the at least one common GUI element. For example, consider the styling of input element 146, which is a common GUI element in both the example representation of the user-facing GUI 140 of FIG. 5 and the example representation of the model-facing GUI 182 of FIG. 7. In the example representation of the user-facing GUI 140 of FIG. 5, input element 146 has associated styling 152 which specifies that input element 146 should have a background colour of green and a colour of blue. In the example representation of the model-facing GUI 182 of FIG. 7, input element 146 has modified associated styling information 186 which specifies that input element 146 should instead have a background colour of black and a colour of white. Therefore, in the example user-facing GUI 160 of FIG. 6, the background 168 of slider 166 would be green while the handle 170 would be blue, whereas in the example model-facing GUI 192 of FIG. 8 the background 168 of slider 166 would be black while the handle 170 would be white. In some implementations, the modified styling of representation of the model-facing GUI may be such that one, some, or all visual components of the model-facing GUI is rendered in black and white, in greyscale, in monochrome, with neutral colours, or in another colouring scheme. In some implementations, accent colours may be applied to one or more GUI elements. Modifications to colour may be used to help focus the generative ML model 126 on specific sections of the model-facing GUI, improving the relevancy of responses. Colour may also be used to simplify the model-facing GUI, which may help the generative ML model 126 focus on relevant sections of the model-facing GUI.

In some implementations, a modification of the styling of at least one common GUI element in the representation of the model-facing GUI as compared to in the representation of the user-facing GUI may comprise a modification to a dimension of the at least one common GUI element. For example, consider the styling of section element 142. In the example representation of the user-facing GUI 140 of FIG. 5, section element 142 has associated styling 154 which specifies that section element 142 should have a width of 80% its parent element, body element 156. In the example representation of the model-facing GUI 182 of FIG. 7, section element 142 has modified associated styling information 188 which specifies that section element 142 should instead have a width of 100% of its parent element, body element 156. Although not illustrated, in both example user-facing GUI 160 and example model-facing GUI 182, the visual component represented by body element 156 has dimensions equal to 100% of the width and 100% of the height of the GUI. Therefore, in the example user-facing GUI 160 of FIG. 6, section 170 spans 80% of the width of the GUI, whereas in the example model-facing GUI 182 of FIG. 8 the section 170 spans 100% of the width of the GUI. In some implementations, either or both of the height and width of a common GUI element may be modified. In some implementations, dimensions that may be modified may be specified in units other than percent, e.g. pixels, viewport units, etc.

In some implementations, a modification of the styling of at least one common GUI element in the representation of the model-facing GUI as compared to in the representation of the user-facing GUI may comprise a modification to a font of the at least one common GUI element. For example, consider the styling of span element 144. In the example representation of the user-facing GUI 140 of FIG. 5, span element 144 has associated styling 150 which specifies that span element 144 should have a font size of 1 rem and a font style of italic. In the example representation of the model-facing GUI 182 of FIG. 7, span element 144 has modified associated styling information 184 which specifies that span element 144 should instead have a font size of 1.5 rem and a font style of normal. This modification can also be seen in the example user-facing GUI 160 and the example model-facing GUI 192. In the example user-facing GUI 160 of FIG. 6, text 164 is small and italicized, whereas in the example model-facing GUI 192 of FIG. 8, text 164 is larger and not italicized. In some implementations other aspects of a font may also be modified, e.g. the font family, the font weight, font anti-aliasing etc.

In some implementations, the representation of the model-facing GUI and the representation of the user-facing GUI may use the same font for at least one common GUI element. In such implementations, if the model-facing GUI has a smaller size and/or resolution, the font in the model-facing GUI may be rendered at a smaller size than the same font in the user-facing GUI using responsive font rendering techniques, e.g. hinting, anti-aliasing, subpixel rendering etc. This may enable the visual component containing the font to be rendered at a lower resolution and/or smaller size in the model-facing GUI than in the user-facing GUI, while still remaining legible to the generative ML model 126. In contrast, merely scaling the font down using pixel wise down sampling may make the font illegible to the generative ML model 126, as described above.

In some implementations, the representation of the model-facing GUI and the representation of the user-facing GUI may use different fonts for at least one common GUI element. In some implementations, the representation of the model-facing GUI may use a font that is clearer than the font used in the representation of the user-facing GUI when rendered at a lower resolution or rendered smaller. In some implementations, the representation of the model-facing GUI may use a font that was widely used in the data used to train generative ML model 126, e.g. a browser default font.

In some implementations, a modification of the styling of at least one common GUI element in the representation of the model-facing GUI as compared to in the representation of the user-facing GUI may comprise modifying other attributes of at least one common GUI element. In some implementations, at least one common GUI element may be modified such that there is no anti-aliasing in the model-facing GUI.

In some implementations of the method of FIG. 4, obtaining the representation of the model-facing GUI may include modifying the dimensions and/or layout of one or more GUI elements, as compared to the dimensions and/or layout of one or more of these GUI elements in the representation of the user-facing GUI. In some implementations, the relative order and/or position of GUI elements in relation to other GUI elements may be maintained such that the relative order and/or position of visual components is substantially the same in the model-facing GUI and the user-facing GUI. This may allow the generative ML model 126 and the user to communicate using semantic descriptions of the visual components, e.g. “the button next to the picture of a chair”. In some implementations, modifying the dimensions and/or layout of one or more of the GUI elements may help improve the quality of responses from the generative ML model 126 by ensuring the aspect ratio of any portions of the model-facing GUI transmitted to the generative ML model 126 are within a defined range, e.g. the range of aspect ratios on which the generative ML model 126 has been trained or within a defined tolerance of an aspect ratio best supported by the generative ML model 126. In some implementations, modifying the dimensions and/or layout of one or more of the GUI elements may help ensure that any portions of the model-facing GUI transmitted to the generative ML model 126 have a specific resolution which may also help improve the quality of responses from the generative ML model, e.g. where the generative ML model 126 has been trained using GUIs with the specific resolution. For example, example user-facing GUI 160 in FIG. 6 has a resolution of 2560×1080, whereas example model-facing GUI 192 in FIG. 8 has a resolution of 500×750, which may be a resolution that generative ML model 126 has been trained with. Although not shown, the dimensions and layout of GUI elements is therefore modified in the example representation of the model-facing GUI 182 as compared to the example representation of the user-facing GUI 140 such that a resolution of 500×750 can be achieved. The effects of this can be seen in comparing the example model-facing GUI 192 to the example user-facing GUI 160, e.g. in example model-facing GUI 192 delete button 172 is stacked under update button 174 instead of being to the right of update button 174, text 176 is wrapped instead of being on a single line, and some whitespace is removed.

In some implementations of the method of FIG. 4, the representation of the user-facing GUI may comprise a plurality of GUI elements and at least one of the plurality of GUI elements may be omitted in the representation of the model-facing GUI. In such implementations, a visual component in the user-facing GUI that is represented by a GUI element that is present in the representation of the user-facing GUI but is omitted from the representation of the model-facing GUI may not be present in the model-facing GUI. As an example, nav element 148 is present in the example representation of the user-facing GUI 140 in FIG. 5 but omitted in the example representation of the model-facing GUI 182 in FIG. 7. As such, a navigation side bar 178 is present in the example user-facing GUI 160 in FIG. 6, but no navigation side bar appears in the example model-facing GUI 192 in FIG. 8. Omitting irrelevant, distracting, ornamental, or otherwise unimportant GUI elements (e.g. animations, whitespace, spacer elements, etc.) from the representation of the model-facing GUI, and therefore omitting their corresponding visual components from any captured portions of the model-facing GUI, may allow for better compression of the captured portions. It may also or instead help the generative ML model 126 focus on information contained in relevant sections of the user-facing GUI. For example, if a user were seeking help from the generative ML model 126 regarding their email setting, the relevant section of the example user-facing GUI 160 may include label 178 and email input 180. In this example, the generative ML model 126 may focus better on these components if it does not also see navigation side bar 178. Therefore, navigation side bar 178 may be omitted from the model-facing GUI, as shown in the example model-facing GUI of FIG. 8.

In some implementations, the method of FIG. 4 may further comprise determining that there is a change in the representation of the user-facing GUI. This change may be based on user input, e.g. the user entered information, the user moved the pointer, the user loaded a new page, the user selected a button, etc. In some implementations, the computing system 112 may then obtain a second version of the representation of the model-facing GUI that reflects the change in the representation of the user-facing GUI. In some implementations, the computing system 112 may then render or re-render the model-facing GUI based on the second version of the representation of the model-facing GUI. This may allow the model-facing GUI to continue to mirror the user-facing GUI so that generative ML model 126 can continue to understand what a user is seeing.

In some implementations, prior to being transmitted to the generative ML model 126 at step 134, the captured portions of the model-facing GUI may be annotated. In some implementations, the model-facing GUI may be annotated before portions of it are captured and the annotations may be included in the captured portions.

In some implementations, the model-facing GUI and/or captured portions of the model-facing GUI may be annotated to emphasize a given section of the model-facing GUI. In some implementations, a border (e.g. a box, a circle etc.) may be added to the model-facing GUI or to the captured portion of the model-facing GUI surrounding the given section. For example, in FIG. 8 stippled box 194 is added to emphasize the emails label 196 and slider 166. In some implementations, a visual label (e.g. an arrow, a text label, a number etc.) may be added to the model-facing GUI or to the captured portion of the model-facing GUI to indicate the given section. In some implementations, a different annotation may be used to indicate a given section. The given section may be, for example, a section of interest as described below. Annotating the model facing GUI to indicate a given section may help the generative ML model 126 focus on the given section.

In some implementations, a portion of the model-facing GUI may be annotated with text. This text may describe one or more visual components. For example, where a visual component is or contains an image, text may be added in proximity to the image that describes the content of the image. In some implementations, a visual component may be replaced with a text annotation. For example, as illustrated at 198 in FIG. 8, previously defined alt text may be used to annotate the model-facing GUI, replacing an image. An image is a visual representation of one or more things and includes pictures and icons. Alt text, which is short for “alternative text”, may comprise a short description of an image used to convey its content or function. The example representation of the user-facing GUI 140 in FIG. 5 includes img element 158 which has alt text (“photo of woman smiling”), defined using the HTML “alt” attribute. In the example representation of the model-facing GUI 182 in FIG. 7, img element 158 has been replaced with span element 190 which contains the alt text defined for img element 158. As such, while example user-facing GUI 160 in FIG. 6 includes avatar 162, example model-facing GUI 192 in FIG. 8 includes text box 198 in its place. Using text annotations to describe visual components may help the generative ML model 126 better understand the captured portion(s) of the model-facing GUI. Replacing images with their alt text or with a description of their content may also allow for more efficient compression of the captured portions. In some implementations, both the image and its alt text may be included in the model-facing GUI.

In some implementations, a portion of the model-facing GUI may be annotated to mask information contained in the GUI, e.g. information contained in a visual component. Masking is when information is obscured, obfuscated, or redacted. In some implementations, an overlay may be applied to mask information. For example, as illustrated in FIG. 8, an opaque shape may be applied over irrelevant or sensitive information. The example model-facing GUI 192 is annotated with opaque rectangle 200 which masks email input 180. Email input 180 is visible in the example user-facing GUI 160 in FIG. 6. In some implementations, masking information in the model-facing GUI may comprise modifying the styling of the corresponding GUI element in the representation of the model-facing GUI such that its corresponding visual component is hidden. For example, if the corresponding GUI element were a HTML element with CSS styling, its associated visibility property could be set to a value of “hidden”. Masking information may help the generative ML model 126 focus on relevant portions of the GUI. Masking information may help with compression, e.g. if the captured portion of the model-facing GUI is compressed for transmission to the generative ML model 126, and if an irrelevant section of the captured portion is masked with a black box, that section may be better compressed. Masking sensitive information, e.g. a user's personal information, may help ensure that such information remains private and is not provided to the generative ML model 126, especially if the generative ML model 126 retains information provided to it during operation for the purposes of future training.

In some implementations, the method of FIG. 4 may further comprise obtaining a description relating to a section of the model-facing GUI. For example, the computing system 112 may obtain text comprising a semantic description of the functionality of a given section of the model-facing GUI. In some implementations, the computing system 112 may obtain a description relating to one or more sections of the user-facing GUI. For example, in the context of a support session with an AI support agent, the user may talk to or chat with the AI support agent, e.g. ask it questions or describe sections of the user-facing GUI, and therefore the system may obtain audio input comprising the user's voice and/or text input from the user describing one or more sections of the user-facing GUI. In some implementations, descriptions (textual and/or audio) may be transmitted to the generative ML model 126 along with the captured portion(s) of the model-facing GUI. In some implementations, the computing system 112 may obtain at least one description relating to annotations of the model-facing GUI and transmit this description to the generative ML model 126 along with the captured portions of the model-facing GUI. For example, computing system 112 may obtain descriptions of the meaning of each border, each visual label, and/or each instance of masked information.

In some implementations, the method of FIG. 4 may further comprise determining that one or more sections of the user-facing GUI are sections of interest that should be emphasized or highlighted to the generative ML model 126. For example, in a support session with an AI agent, a user may ask a question about or refer to a section of the user-facing GUI. It may be helpful to direct the attention of the generative ML model 126 to the section the user is talking about.

In some implementations, the method of FIG. 4 may further comprise rendering and presenting the user-facing GUI to the user, e.g. displaying the user-facing GUI on client device 102. In some implementations, the computing system 112 may determine that a given section of the user-facing GUI is a section of interest based on user interaction with the presented user-facing GUI, e.g. the computing system 112 may determine that there is a specific section of the user-facing GUI with which the user is interacting. This section may be a section of interest that should be emphasized or highlighted to the generative ML model 126. In some implementations, after identifying a section of interest of the user-facing GUI, the computing system 112 may then determine a corresponding section of the model-facing GUI. In such implementations, capturing the at least one portion of the model-facing GUI at step 132 may comprise capturing the corresponding section of interest in the model-facing GUI. In some implementations, the captured portions of the model-facing GUI may comprise more than the sections of interest and the sections of interest may be emphasized or highlighted within the captured portions. In some implementations, the captured portions may only comprise the sections of interest. In some implementations, the computing system 112 may determine a section of interest by identifying at least one GUI element with which the user is interacting through the user-facing GUI and then may determine, based on the GUI element with which the user is interacting, a corresponding section of the model-facing GUI.

In some implementations, the user may indicate that a section of the user-facing GUI is of interest by gesturing to the section of the user-facing GUI with a pointer, e.g. by moving the pointer around the section, moving the pointer to the location of the section, or selecting an element within the section. A pointer as used herein means any representation of the position of a user's input and includes a cursor or (in the case of a touch screen) a stylus or finger. In some implementations, a user may indicate that a section of the user-facing GUI is of interest by interacting with a given GUI element, e.g. by hovering over, clicking on, or otherwise selecting a particular visual component that is represented by the given GUI element. For example, a user may indicate that particular text is of interest by selecting the text. In some implementations, the computing system 112 may determine that the user is indicating a section of interest with the pointer based on other user input. For example, if the user is circling a given section of the user-facing GUI with the pointer while describing a problem they are having with the software application, the computing system 112 may determine that the given section is a section of interest.

In some implementations, the computing system 112 may prompt the user to indicate a section of interest. In some implementations, the computing system 112 may transform the pointer into a viewport or a selection tool that allows the user to select a specific section of interest on their screen and displays that selection to the user. In some implementations, the computing system 112 may transform the pointer to have an overlay, e.g. viewport, that shows the user the section of the user-facing GUI that they are identifying as a section of interest.

In some implementations, the computing system 112 may track which sections of the user-facing GUI are associated with the last N user interactions. The computing system 112 may determine that one or more of these tracked sections are sections of interest. In some implementations, the computing system 112 may provide the generative ML model 126 with additional information related to the user's last N interactions along with the captured portions of the model-facing GUI. For example, the system may obtain a semantic description of the user's last N interactions and transmit the semantic description to the generative ML model 126 along with the captured portions of the model-facing GUI. In some implementations, the information related to the user's previous interactions may indicate the user's previous interactions directly (e.g. “the user previously selected the refresh button”), and/or be or include previous GUI captures showing the user's previous interactions, and/or the information may indicate system actions associated with the user's previous interactions (e.g. API calls, browser events, etc.). In some implementations, the information related to the user's previous interactions may be sent to the generative ML model 126 with the current captured portion of the model-facing GUI or possibly also with previously captured portions of the model-facing GUI (e.g. that relate to the user's previous interactions).

In some implementations, the computing system 112 may identify a section of interest based on recent changes to the user-facing GUI. For example, the computing system 112 may determine that a visual component that was added or updated just prior to a user's request for support may be relevant to that request for support and therefore identify a section of the user-facing GUI containing that component as a section of interest.

In some implementations, a section of interest of the user-facing GUI may be represented by a set of one or more GUI elements that represent one or more visual components within the given section. In some implementations where the user has selected a specific GUI element by interacting with it or otherwise indicated that a given GUI element is of interest, the computing system 112 may determine a set of related GUI elements that when combined with the given GUI element, represent the section of interest. In some implementations, the system may determine that all GUI elements representing visual components within a defined area represent a section of interest. For example, if the user has used a selection tool to indicate a rectangle on their screen that is of interest, all GUI elements representing visual components within the rectangle may represent a section of interest. In implementations where the user-facing GUI is a webpage, the system may determine related GUI elements based on the browser DOM. For example, if the user has selected a menu item, the system may determine that all GUI elements that make up the menu form the section of interest.

In some implementations, once the computing system 112 has determined a set of GUI elements in the representation of the user-facing GUI that represent a section of interest, the computing system 112 may map the set of GUI elements in the representation of the user-facing GUI to a corresponding set of GUI elements in the representation of the model-facing GUI. The corresponding set of GUI elements may represent the visual components that comprise the section of interest in the model-facing GUI. In some implementations, the set of related GUI elements may be determined such that the corresponding section of interest in the model-facing GUI has a specific aspect ratio and/or resolution. For example, a section of interest may be determined such that the corresponding section of the model-facing GUI has an aspect ratio preferred by the generative ML model 126 and also encompasses one or more GUI elements of interest. In some implementations, the corresponding section of interest in the model-facing GUI may be cropped such that the cropped version has a specific aspect ratio and/or resolution.

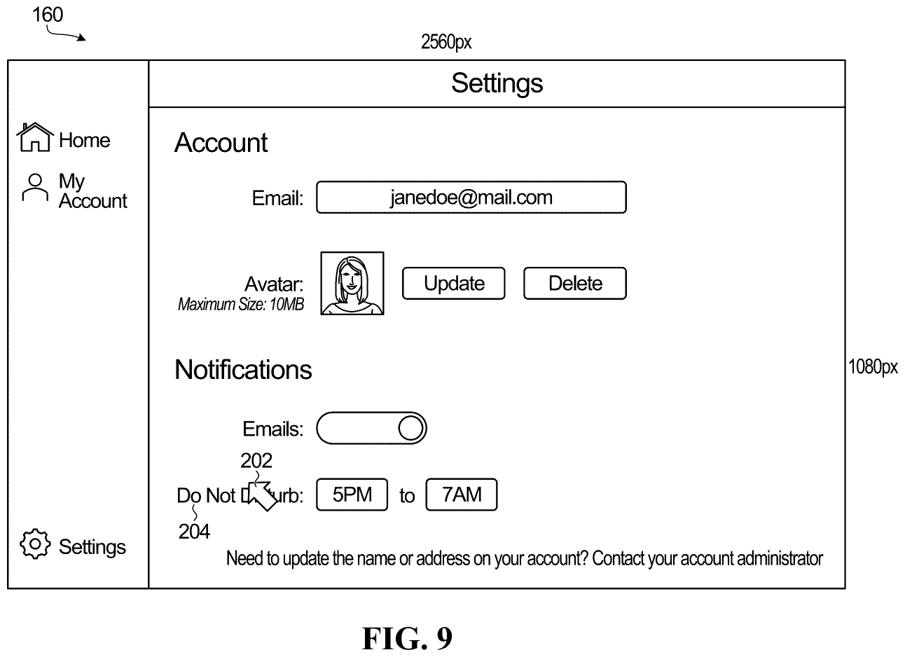

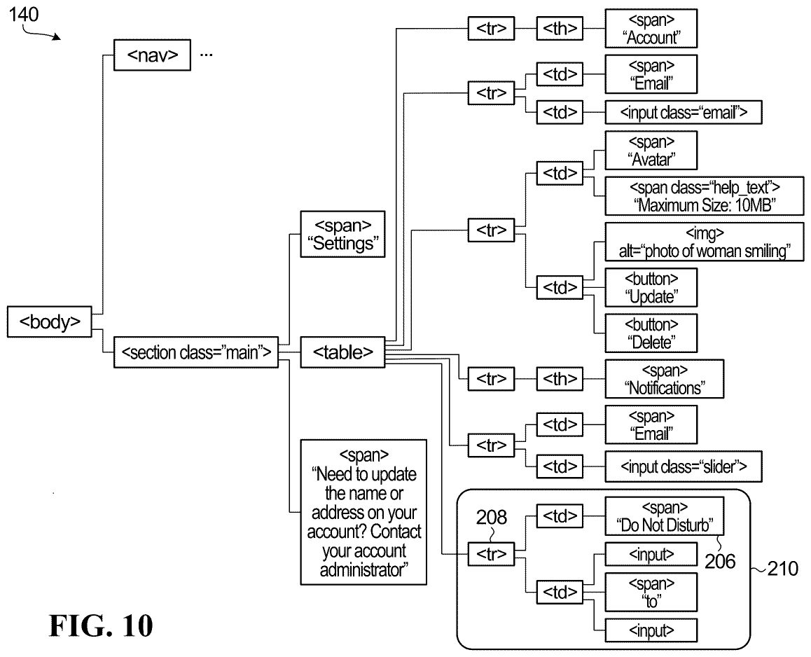

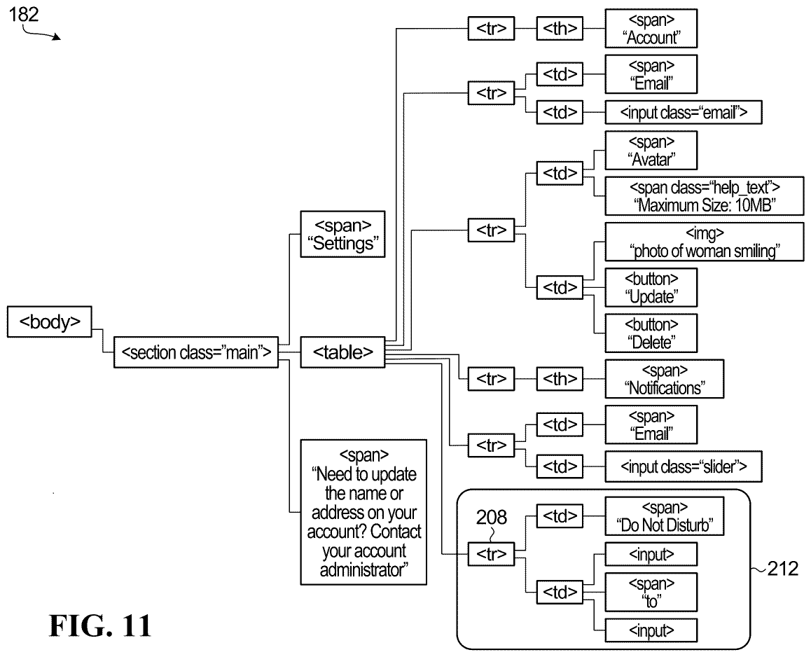

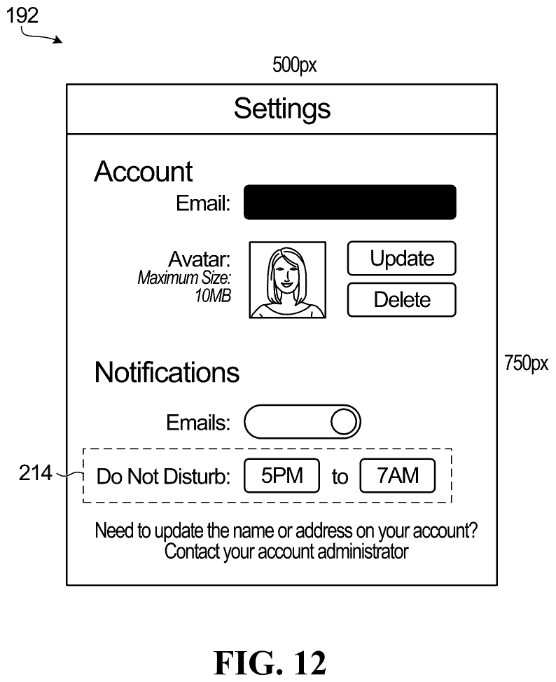

An example of determining a section of interest is illustrated in FIGS. 9 to 12. In this example, and with reference to FIG. 9, the user is interacting with example user-facing GUI 160 has asked an AI support agent “what does this setting do?” while their pointer 202 is hovering over label 204, which reads “Do Not Disturb”. The computing system 112 may therefore identify that the user is interacting with the visual component corresponding to span element 206, as illustrated in the example representation of the user-facing GUI 140 in FIG. 10. The computing system 112 may then determine that the section of interest comprises span element 206 as well as related GUI elements. In this example, the computing system 112 may determine based on the example DOM tree representation of the user-facing GUI 140 that span element 206 is part of a table. Therefore, the computing system 112 may determine that the entire row of the table that contains span element 206 constitutes a section of interest. Computing system 112 may therefore select all GUI elements with the same parent <tr>(table row) GUI element as span element 206, namely all GUI elements that are children of tr element 208, as the GUI elements representing the section of interest. The set of GUI elements that represent the section of interest are indicated by oval 210. As illustrated in FIG. 11, the computing system 112 may then map this set of GUI elements to a corresponding set of GUI elements in the example representation of the model-facing GUI 182. The computing system 112 may identify <tr>element 208 in the example DOM tree representation of the model-facing GUI 182 and determine that the corresponding set of GUI elements comprises the children of <tr>element 182, as indicated by oval 212. This corresponding set of GUI elements represents the visual components that comprise the section of interest in the model-facing GUI. Then, as illustrated in FIG. 12, the computing system 112 may annotate the example model-facing GUI 192 to indicate the section of interest. In this example, the section of interest is outlined with stippled box 214. At least a portion of example model-facing GUI 192, including stippled box 214, may then be captured and transmitted to the generative ML model 126. The generative ML model may also be prompted with the user's question “what does this setting do?”.

In some implementations, after receiving the captured portion(s) of the model-facing GUI, the computing system 112 may receive a request from the generative ML model 126 for a particular portion of the model-facing GUI that is different from captured portion(s) previously transmitted to the generative ML model 126. For example, the generative ML model 126 may request a portion of the model-facing GUI that includes fewer visual components, that has a more legible font, and/or that has a different aspect ratio, etc. In another example, the generative ML model 126 may request a portion of the model-facing GUI containing visual components that had not been included in the captured portion(s) previously transmitted. The computing system 112 may then capture the requested particular portion of the model-facing GUI and transmit it to the generative ML model 126. In some implementations, a second ML model, e.g. an object detection model, may be used to determine which portions of the model-facing GUI the generative ML model 126 is requesting.

The model-facing GUI may be stored and transmitted using a variety of methods. In some implementations, a system, e.g. computing system 112, may store a template of the model-facing GUI server-side and update the template as the state of the user-facing GUI changes. In some implementations, a client hosting the software application with which the user is interacting may transmit an identifier to a downstream server, the identifier being used to retrieve a matching template of the model-facing GUI. In such cases, the client may simply transmit user interaction information, e.g. pointer movements and selections, to the server and the server may update the model-facing GUI accordingly, prior to transmitting portions of it to the generative ML model 126.

In some implementations, there may be more than one model-facing GUI, each optimized for a different generative ML model.

Technical benefits of the implementations of the method of FIG. 4 described herein include the following. By obtaining a representation of a model-facing GUI that is a modified version of a representation of a user-facing GUI and rendering the model-facing GUI such that at least one visual component is modified as compared to the user-facing GUI, a version of the GUI may be rendered that is better suited to be clearly interpreted from an image processing perspective by a generative ML model. Therefore, the generative ML model may understand the content of the GUI better when provided with the model-facing GUI as compared to the user-facing GUI. The generative ML model therefore may provide more helpful and accurate responses, and technical problems such as hallucination may be mitigated.

In some circumstances, it may be desirable to obtain a GUI well suited for use in prompting a generative ML model without the representation of the GUI necessarily being a modified version of a user-facing representation of a GUI. Computer-executable code defining model-specific styling can be obtained and applied to a set of GUI elements. Then, when the set of GUI elements is rendered, the resulting GUI may be well suited for use in prompting a generative ML model.

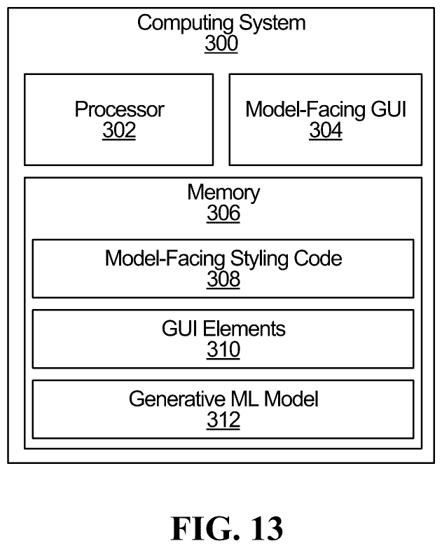

FIG. 13 illustrates another example system for generating GUIs for processing by a generative ML model. The system includes computing system 300. The computing system 300 includes a processor 302 and a memory 306. The processor 302 controls the operations of the computing system 300. The processor 302 may be implemented by one or more processors that execute instructions stored in the memory 306. Alternatively, some or all of the processor 302 may be implemented using dedicated circuitry, such as an application specific integrated circuit (ASIC), a graphics processing unit (GPU), or a programmed field programmable gate array (FPGA). The memory 306 stores information (e.g. content and/or instructions, etc.).

In some implementations, the computing system 300 may be distributed, e.g. it may comprise one or more servers or computing devices, in which case processor 302 might actually consist of multiple processors communicating with each other over a communication link (e.g. over a network), and similarly memory 306 might be distributed across multiple servers or computing devices.

In the example system, computing system 300 further include a model-facing GUI 304. The model-facing GUI 118 may be rendered (e.g. by processor 302) without necessarily being presented on a display.

In the example system, the memory 306 stores model-facing styling code 308 and GUI elements 310. Model-facing styling 308 code may comprise computer-executable code defining styling to be applied to GUI elements, e.g. GUI elements 310. In some implementations, model-facing styling code 308 may comprise CSS source code. In some implementations, model-facing styling code may comprise other computer-executable code that defines the appearance, layout, and/or behavior of GUI elements. GUI elements 310 may comprise a set of GUI elements where each represents a visual component of model-facing GUI 304. A GUI element may be an HTML element (e.g. button, input, div, img, etc.), a window, a pointer, a menu, an icon, etc. GUI elements may be nested, e.g. a GUI element may have parent, sibling, and/or child GUI elements.

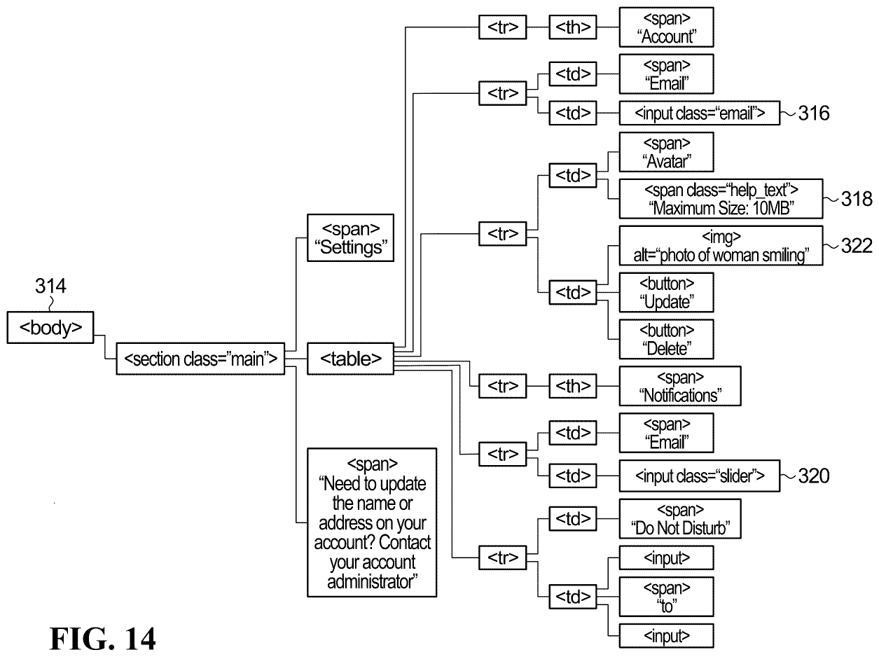

An example of GUI elements 310 is illustrated in FIG. 14. In this example, model-facing GUI 304 is implemented using at least HTML and, as such, GUI elements 310 may be depicted as a DOM tree. In other implementations, the model-facing GUI 304 and GUI elements 310 may be implemented differently. For example, the model-facing GUI 304 may be implemented using other GUI frameworks/libraries/toolkits, e.g. Tkinter, Swing, WinUI, AppKit, etc. In the illustrated example, each node of the illustrated DOM tree represents a GUI element of GUI elements 310. GUI elements 310 may also comprise additional GUI elements that are not illustrated. Additionally, the GUI elements that are illustrated as nodes of the DOM tree may have additional attributes that are not illustrated. For example, they may have attributes such as class, type, src, id, etc.

Returning to FIG. 13, in the example system, the memory 306 further stores generative ML model 312. By “storing” the generative ML model 312, it is meant that the parameters and other values that make up the model and that are required for execution of the model are stored. The parameters depend upon how the generative ML model 312 is implemented. For example, assuming the generative ML model 312 utilizes one or more neural networks, the weights and biases of the one or more neural networks are stored.

The generative ML model 312 may be implemented as or using a multimodal model. In some implementations, generative ML model 312 may have a similar structure to the example LLM structure described earlier in relation to FIG. 1B, or it may have another structure. The exact structure of the generative model 312 is implementation specific.

The generative ML model 312 may be implemented by the processor 302. In some implementations, the processor 302 may be a specialized processing unit, e.g. one designed to accelerate computer operations of a generative model through parallelization of operations, which may allow for faster execution of the generative ML model 312 compared to a more general-purpose processing unit. For example, the processor 302 may be or include a GPU or a tensor processing unit (TPU) or a neural processing unit (NPU) or a hardware accelerator. In some implementations, the processor 302 may comprise a specialized processing unit paired with a general-purpose processing unit, e.g. a computer, central processing unit (CPU), and/or other computing device such as a server. In some implementations, the processor 302 may be monolithic such as, for example, a single computing device or a single integrated circuit of such a device. However, this is not required. In other implementations, the processor 302 may comprise one or more computing devices acting in cooperation. For example, the processor 302 may consist of a general purpose computing device (e.g., a conventional server) communicatively coupled to a specialized computing device adapted for execution of generative ML models.

In some implementations, the generative ML model 312 may be stored/executed separately, not on the computing system 300. This, for example, may be another form of arrangement involving cooperating computing devices. In a particular example, the computing system 300 may communicate with the generative ML model 312 by sending prompts over a network via a generative model interface to the generative ML model 312 and receiving responses back from the generative ML model 312. In some implementations, the generative ML model 312 may be provided by a software-as-a-service (SaaS) provider, e.g. OpenAI™, Microsoft Azure™, etc.

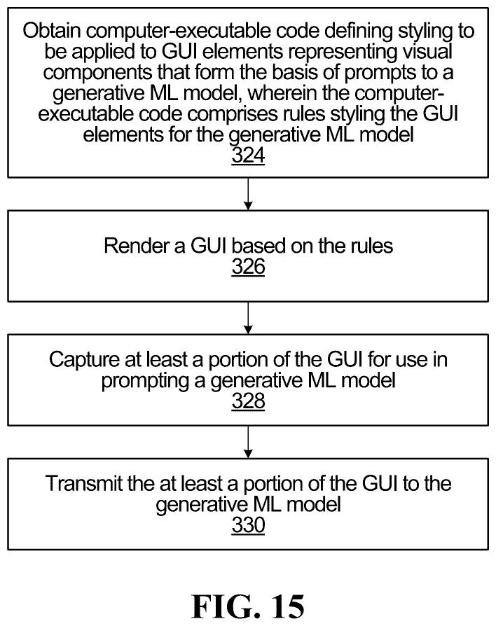

FIG. 15 illustrates an example method performed by computing system 300, according to some implementations.

At step 324, the computing system 300 obtains computer-executable code defining styling to be applied to GUI elements 310 representing visual components that form the basis of prompts to a generative ML model. This computer-executable code may be referred to herein as model-facing styling code 308. The model-facing styling code 308 comprises rules styling the GUI elements for the generative ML model 312.

At step 326, the computing system 300 renders a GUI, which may be referred to herein as a model-facing GUI 304. In some implementations, the computing system 300 renders the model-facing GUI 304 without presenting it on a display. For example, it may not be necessary to make the model-facing GUI 304 visible to the user if the user is interacting with the computing system (e.g. with a software application implemented by the computing system) using another GUI, such as a user-facing GUI. The model-facing GUI 304 may reflect/mirror the user-facing GUI and be used for sending screen captures to the generative ML model 312, with just the user-facing GUI presented to the user on a display. Presenting the model-facing GUI on the display may cause the user confusion or provide for a negative machine-user interaction experience because the model-facing GUI 304 might not be as visually attractive, functional, and/or complete. Alternatively, the model-facing GUI 304 might be presented to the user on a display, e.g. for the reason explained earlier in terms of possibly facilitating better communication between the user and the generative ML model 312. In other implementations, a hybrid approach may be utilized in which the user-facing GUI has at least a portion thereof modified (e.g. the styling of one or more GUI elements modified) to reflect the corresponding portion of the model-facing GUI 304, so that the user can better understand what is sent to the generative ML model 312.

At step 328, the computing system 300 captures at least a portion of the model-facing GUI 304 for use in prompting generative ML model 312. In some implementations, the captured portion of the model-facing GUI 304 may comprise the entire model-facing GUI 304. In some implementations, only some of the model-facing GUI 304 may be captured. For example, computing system 300 may capture only portions of the model-facing GUI 304 that are of interest in a given context.

At step 330, the computing system 300 transmits the at least a portion of the model-facing GUI 304 to the generative ML model 312. In some implementations, the computing system 300 prompts the generative ML model 312 with the at least a portion of the model-facing GUI 304. In some implementations, in addition to being prompted with one or more captured portions of the model-facing GUI 304, the generative ML model 312 may be prompted with additional information. In some implementations, the computing system 300 transmits other information to the generative ML model 312 along with the at least a portion of the model-facing GUI 304. For example, the computing system 300 may prompt the generative ML model 312 with the at least a portion of the model-facing GUI 304 along with additional text, audio, etc.

In some implementations, the method of FIG. 15 may further comprise obtaining other computer-executable code, which may be referred to herein as user-facing styling code. The user-facing styling code may define second styling to be applied to the GUI elements 310. In some implementations, the computing system 300 may render the GUI elements 310 based on the second styling, defined by the user-facing styling code, for presentation on a display, e.g. presentation on a user device, such as client device 102 described earlier. In some implementations, the styling defined by the model-facing styling code 308 may be modified compared to the second styling (defined by the user-facing styling code). In some implementations, the styling defined by the model-facing styling code 308 may be modified compared to the second styling by a modification to at least one of: a colour of at least one of the GUI elements 310, a dimension of at least one of the GUI elements 310, or a font of at least one of the GUI elements 310. In some implementations, other modifications may be included. These modifications may help ensure the model-facing GUI is better suited to use in prompting the generative ML model 312 as compared to a GUI rendered based on GUI elements 310 and the user-facing styling code.

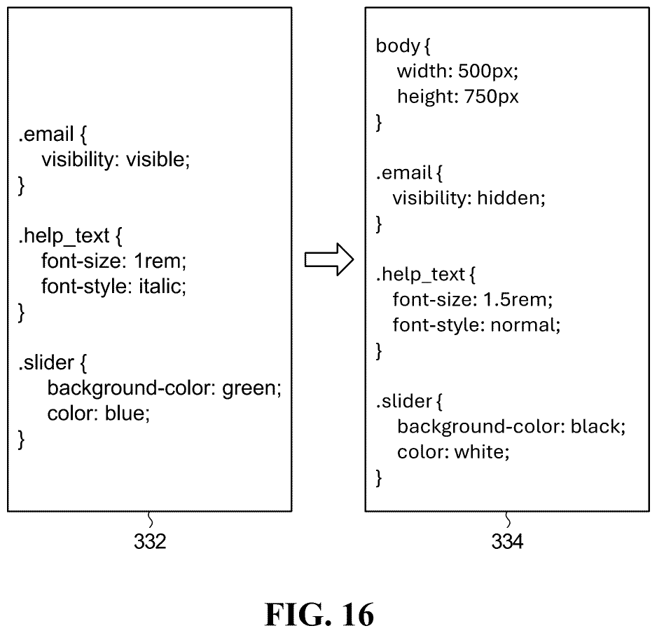

FIG. 16 illustrates an example of modifying styling information, according to some implementations. In FIG. 16, example user-facing styling code 332 and example model-facing styling code 334 both comprise CSS code. Both example user-facing styling code 332 and example model-facing styling code 334 may be applied to the example of GUI elements 310 illustrated in FIG. 13. In the example of FIG. 14 and FIG. 16, the styling defined by the example model-facing styling code 334 is modified in the following ways as compared to the styling defined by example user-facing styling code 332: the dimensions of body element 314 are modified such that model-facing GUI 304 will have a specific resolution, input element 316 (which has class attribute “email”) is hidden, the font size and style of span element 318 (which has class attribute “help_text”) are modified, and the colours of input element 320 (which has class attribute “slider”) are simplified. Modifying styling rules such that model-facing GUI 304 has a specific resolution may help improve the quality of responses from the generative ML model 312 as described below. Modifying styling rules such that at least one GUI element is hidden may help focus the generative ML model 312 on relevant portions of the model-facing GUI 304. Hiding at least one GUI element in the model-facing GUI may also allow for better compression of the at least a captured portion. Simplifying colours, or modifying colours in other ways as described below, may help focus the generative ML model on relevant sections of the model-facing GUI 304.

In some implementations, the model-facing styling code 308 may comprise CSS source code. For example, a CSS class modifier may be added to each of GUI elements 310 such that CSS code comprising rules styling each GUI element for the generative ML model 312 is applied when the model-facing GUI 304 is rendered. In another example, a CSS media query may be used to apply the rules styling the GUI elements 310 for the generative ML model 312 when the model-facing GUI 304 is rendered.

In some implementations, the model-facing styling code 308 may comprise at least one rule that, when applied to a GUI element, affects at least one colour attribute of the GUI element. For example, the at least one rule may set the colours of at least one GUI element such that the model-facing GUI 304 is rendered in black and white, in greyscale, in monochrome, with neutral colours, or in another colouring scheme. In some implementations, the at least one rule may be such that accent colours are be applied to one or more GUI elements. Modifications to colour may be used to help focus the generative ML model 312 on specific sections of the model-facing GUI 304. Colour may also or instead be used to simplify the model-facing GUI 304, which may help the generative ML model 312 focus on relevant sections of the model-facing GUI 304.

In some implementations, the method of FIG. 15 may further comprise determining that a GUI element includes an image. For example, referring to the example illustration of GUI elements 310 in FIG. 14, computing system 300 may determine that img element 322 includes an image. In some implementations, the computing system 300 may then annotate the image with defined alt text. Alt text, or alternative text, may comprise a short description of an image used to convey its content or function. In some implementations, the alt text may be added to the model-facing GUI 304 in proximity to the image. In some implementations, the image may be replaced with the alt text. Annotating the model-facing GUI 304 with alt text may help the generative ML model 312 better understand the captured portion(s) of the model-facing GUI 304. Replacing images with their alt text may also allow for more efficient compression of the captured portions.

In some implementations, the model-facing styling code may comprise at least one rule that, when applied to the GUI elements 310, arranges the GUI elements 310 such that the model-facing GUI 304 has a specific aspect ratio and/or resolution. In some implementations, the generative ML model 312 may have been trained using GUIs with the specific aspect ratio and/or resolution. Arranging the GUI elements 310 such that the model-facing GUI has a specific aspect ratio and/or resolution may help improve the quality of responses from the generative ML model 312 by ensuring the aspect ratio and/or resolution of any portions of the model-facing GUI 304 transmitted to the generative ML model 312 are within a defined range, e.g. the range of aspect ratios and/or resolutions on which the generative ML model 312 has been trained or within a defined tolerance of an aspect ratio and/or resolution best supported by the generative ML model 312.

In some implementations, the method of FIG. 15 may further comprise, prior to transmitting the at least one captured portion to the generative ML model 312, identifying at least one section of the captured portion of the model-facing GUI 304. In some implementations, this may be a section that should be emphasized to the generative ML model 312, e.g. a section of interest. In some implementations, the computing system 300 may then annotate the captured portion of the GUI to indicate the at least one section. In some implementations, a border (e.g. a box, a circle etc.) may be added to the model-facing GUI 304 or to the captured portion of the model-facing GUI 304 surrounding each given section. In some implementations, a visual label (e.g. an arrow, a text label, a number etc.) may be added to the model-facing GUI or to the captured portion of the model-facing GUI to indicate each given section. In some implementations, a different annotation may be used to indicate a given section.

In some implementations, the method of FIG. 15 may further comprise obtaining a description relating to at least one section of the model-facing GUI 304. For example, the computing system 300 may obtain a semantic description relating to one or more sections of the model-facing GUI. In some implementations, the computing system 300 may then transmit the description to the generative ML model 312 along with the at least a captured portion of the model-facing GUI 304.

In some implementations, the method of FIG. 15 may further comprise, subsequent to step 330, receiving, from the generative ML model 312, a request for a particular portion of the model-facing GUI 304. In some implementations, the particular portion may be different from the at least one captured portion of the model-facing GUI 304 already transmitted to the generative ML model. For example, the generative ML model 312 may request a portion of the model-facing GUI 304 that includes fewer visual components, that has a more legible font, and/or that has a different aspect ratio etc. In another example, the generative ML model 314 may request a portion of the model-facing GUI containing visual components that had not been included in the captured portion(s) previously transmitted. In response, the computing system 300 may capture the particular portion of the model-facing GUI 304 and transmit it to the generative ML model 312. In some implementations, a second ML model, e.g. an object detection model, may be used to determine which portions of the model-facing GUI the generative ML model 126 is requesting.

Technical benefits of the implementations of the method of FIG. 15 described herein include the following. By rendering a GUI based on rules styling its GUI elements for use in prompting a generative ML model, a version of the GUI, referred to as the model-facing GUI, may be rendered that is well suited to be clearly interpreted from an image processing perspective by a generative ML model. Therefore, the generative ML model may understand the content of the GUI better when provided with the model-facing GUI as compared to a version of the GUI rendered based on other styling rules. The generative ML model therefore may provide more helpful and accurate responses, and technical problems such as hallucination may be mitigated.

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

1. A computer-implemented method comprising:
obtaining computer-executable code defining styling to be applied to graphical user interface (GUI) elements representing visual components that form the basis of prompts to a generative machine learning (ML) model, wherein the computer-executable code comprises rules styling the GUI elements for the generative ML model;
rendering a GUI based on the rules without presenting the GUI on a display;
capturing at least a portion of the GUI for use in prompting the generative ML model; and
transmitting the at least a portion of the GUI to the generative ML model.

2. The method of claim 1, wherein the computer executable code comprises cascading style sheets (CSS) source code.

3. The method of claim 1, wherein the styling is a first styling, and wherein the method further comprises:
obtaining other computer-executable code defining second styling to be applied to the GUI elements; and
rendering the GUI elements based on the second styling for presentation on the display, wherein the first styling is modified compared to the second styling by a modification to at least one of:
a colour of at least one of the GUI elements;
a dimension of at least one of the GUI elements; or
a font of at least one of the GUI elements.

4. The method of claim 1, wherein the rules styling the GUI elements for the generative ML model comprise at least one rule that, when applied to a GUI element, affects at least one colour attribute of the GUI element.

5. The method of claim 1, wherein rendering the GUI comprises:
determining that a GUI element includes an image; and
annotating the image with defined alt text.

6. The method of claim 1, wherein the rules styling the GUI elements for the generative ML model comprise at least one rule that, when applied to the GUI elements, arranges the GUI elements such that the GUI has a specific aspect ratio and/or resolution.

7. The method of claim 6, wherein the generative ML model has been trained using GUIs with the specific aspect ratio and/or resolution.

8. The method of claim 1, further comprising, prior to transmitting the at least a portion of the GUI to the generative ML model:
identifying at least one section of the captured portion of the GUI; and
annotating the captured portion of the GUI to indicate the at least one section.

9. The method of claim 8, further comprising:
obtaining a description relating to the at least one section; and
transmitting the description to the generative ML model along with the at least a portion of the GUI.

10. The method of claim 1 further comprising, subsequent to transmitting the at least a portion of the GUI to the generative ML model:
receiving, from the generative ML model, a request for a particular portion of the GUI, wherein the particular portion is different from the at least one portion of the GUI transmitted to the generative ML model;
capturing the particular portion of the GUI; and
transmitting the particular portion of the GUI to the generative ML model.

11. A non-transitory computer-readable medium having stored thereon computer-executable instructions that, when executed by a computer, cause the computer to perform operations comprising:
obtaining computer-executable code defining styling to be applied to graphical user interface (GUI) elements representing visual components that form the basis of prompts to a generative machine learning (ML) model, wherein the computer-executable code comprises rules styling the GUI elements for the generative ML model;
rendering a GUI based on the rules without presenting the GUI on a display;
capturing at least a portion of the GUI for use in prompting the generative ML model; and
transmitting the at least a portion of the GUI to the generative ML model.

12. The non-transitory computer-readable medium of claim 11, wherein the computer executable code comprises cascading style sheets (CSS) source code.

13. The non-transitory computer-readable medium of claim 11, wherein the styling is a first styling, and wherein the instructions, when executed by the computer, cause the computer to perform operations further comprising:
obtaining other computer-executable code defining second styling to be applied to the GUI elements; and
rendering the GUI elements based on the second styling for presentation on the display, wherein the first styling is modified compared to the second styling by a modification to at least one of:
a colour of at least one of the GUI elements;
a dimension of at least one of the GUI elements; or
a font of at least one of the GUI elements.

14. The non-transitory computer-readable medium of claim 11, wherein the rules styling the GUI elements for the generative ML model comprise at least one rule that, when applied to a GUI element, affects at least one colour attribute of the GUI element.

15. The non-transitory computer-readable medium of claim 11, wherein rendering the GUI comprises:
determining that a GUI element includes an image; and
annotating the image with defined alt text.

16. The non-transitory computer-readable medium of claim 11, wherein the rules styling the GUI elements for the generative ML model comprise at least one rule that, when applied to the GUI elements, arranges the GUI elements such that the GUI has a specific aspect ratio and/or resolution.

17. The non-transitory computer-readable medium of claim 11 wherein the instructions, when executed by the computer, cause the computer to perform operations further comprising, prior to transmitting the at least a portion of the GUI to the generative ML model:
identifying at least one section of the captured portion of the GUI; and
annotating the captured portion of the GUI to indicate the at least one section.

18. The non-transitory computer-readable medium of claim 17 wherein the instructions, when executed by the computer, cause the computer to perform operations further comprising:
obtaining a description relating to the at least one section; and
transmitting the description to the generative ML model along with the at least a portion of the GUI.

19. The non-transitory computer-readable medium of claim 11 wherein the instructions, when executed by the computer, cause the computer to perform operations further comprising, subsequent to transmitting the at least a portion of the GUI to the generative ML model:
receiving, from the generative ML model, a request for a particular portion of the GUI, wherein the particular portion is different from the at least one portion of the GUI transmitted to the generative ML model;
capturing the particular portion of the GUI; and
transmitting the particular portion of the GUI to the generative ML model.

20. A system comprising:
at least one processor; and
a memory storing processor-executable instructions that, when executed by the at least one processor, cause the system to:
obtain computer-executable code defining styling to be applied to graphical user interface (GUI) elements representing visual components that form the basis of prompts to a generative machine learning (ML) model, wherein the computer-executable code comprises rules styling the GUI elements for the generative ML model;
render a GUI based on the rules without presenting the GUI on a display;
capture at least a portion of the GUI for use in prompting the generative ML model; and
transmit the at least a portion of the GUI to the generative ML model.
